(19) United States
(12) Patent Application Publication
(10) Pub. No.: US 2024/0384575 A1
(43) Pub. Date: Nov. 21, 2024

(54) Method and Device for Unlocking a Seat Bench of a Single-Track Motor Vehicle

(71) Applicant: Bayerische Motoren Werke Aktiengesellschaft, Muenchen (DE)

(72) Inventors: Christian ISING, Muenchen (DE); Dieter STRASSER, Oberhausen (DE)

(21) Appl. No.: 18/577,343

(22) PCT Filed: Jun. 8, 2022
(86) PCT No.: PCT/EP2022/065550

§ 371 Date: Jan. 8, 2024

(30) Foreign Application Priority Data
Jul. 9, 2021 (DE) 10 2021 117 748.0

(51) Int. Cl. E05B 83/00; B62H 5/00; B62J 1/08; B62J 45/42

(52) U.S. Cl. CPC E05B 83/00; B62H 5/006; B62J 1/08; B62J 45/42

(57) ABSTRACT

A method is provided for unlocking a seat bench of a single-track motor vehicle using at least one actuator for locking and unlocking the seat bench by a locking element. An actuation element for the actuator is formed on the seat bench. The single-track motor vehicle has a sensor system for detecting current operating parameters of the single-track motor vehicle and a controller for controlling the actuator. At least one specified value for a corresponding operating parameter is stored in the controller. According to the method, the corresponding operating parameter is continuously detected by the sensor system, and the detected operating parameter is then compared by the controller with the respective corresponding specified value. If, upon comparing the detected operating parameter, the operating parameter corresponds to the corresponding specified value and a driver actuates the actuation element, the controller controls the actuator such that the seat bench is unlocked by the unlocking element.

### BACKGROUND AND SUMMARY

The invention relates to a method for unlocking a seat bench of a single-track motor vehicle using at least one actuator for unlocking and for locking the seat bench by means of a locking element. In addition, the invention relates to a device for carrying out the method.

Unlocking the seat bench of a single-track motor vehicle is usually carried out by opening a lock by means of the ignition key. Furthermore, the unlocking often has to be carried out with a cumbersome two-handed operation. For the driver of the single-track motor vehicle it is therefore extremely inconvenient if he wishes to open the seat bench, for example in order to remove an object from a stowage compartment under the seat bench.

It is therefore an object of the present invention to provide a device and a method for unlocking a seat bench which optimizes and simplifies the seat bench unlocking for a driver.

This object is achieved by the feature combination according to the independent claims.

According to the invention, a method is proposed for unlocking a seat bench of a single-track motor vehicle or a quad bike, using at least one actuator for unlocking and for locking the seat bench by way of a locking element. An actuating element for the actuator is formed on the seat bench. Furthermore, the single-track motor vehicle has sensors for detecting current operating parameters of the single-track motor vehicle and a controller for controlling the actuator. In addition, at least one defined value for the corresponding operating parameters is stored in the controller. The method firstly comprises continuously detecting the corresponding operating parameters by means of the sensors and then comparing the detected operating parameters with the respective corresponding defined value by means of the controller. If, in the comparison, the detected operating parameter corresponds to the corresponding defined value and a driver actuates the actuating element, the controller controls the actuator in such a way that the seat bench is unlocked by the locking element.

It is advantageous that, because of the condition for unlocking the seat bench, the latter is not unintentionally unlocked. Furthermore, the seat bench is automatically unlocked and can be removed easily and directly. As a result, the handling is optimized for the driver.

In an advantageous design variant, provision is made for the actuating element to be a handle, a lever, a sensor, an induction loop, a switch or a pushbutton. An induction loop is particularly preferred. In this way, the seat bench is automatically unlocked by touching the seat bench in the areas provided for the purpose, whereby the handling of the unlocking of the seat bench is further optimized for the driver.

Preferably, a status of an ignition of the single-track motor vehicle is determined as an operating parameter during the detection, and the at least one value is an ignition switched on. As a result, the seat bench can be unlocked only when the ignition is switched on.

In an exemplary embodiment of the method, provision is made that a detected radio key is determined as the operating parameter during the detection, and the at least one value is a detected radio key which is located within a defined distance from a radio receiver of the single-track motor vehicle, in particular within 2 meters, more particularly within one meter. It is advantageous that the seat bench can be unlocked by actuating the actuating element as soon as the driver with the radio key is present in the surroundings of the single-track motor vehicle, whereby the operating convenience for the driver is further improved.

In an alternative embodiment, provision is made that a status of an ignition lock of the single-track motor vehicle is determined as the operating parameter during the detection, and the at least one value is a key inserted into the ignition lock. As a result, in an embodiment of the single-track motor vehicle without a radio key, it is ensured that the seat bench is unlocked only when the driver is in possession of the ignition key and inserts the latter into the ignition lock.

In a further advantageous variant, the invention provides that a wheel rotational speed of the single-track motor vehicle is determined as the operating parameter during the detection, and the at least one value is a wheel rotational speed of 0. This prevents the seat bench being unlocked unintentionally during travel with the motorcycle and thus increases the safety for the driver.

Further beneficial is an embodiment in which the seat bench has an occupancy sensor and occupation of the seat bench and a motor speed of the single-track motor vehicle are determined as operating parameters during the detection. The at least one value is an unoccupied seat bench and a motor speed of greater than 0. It is advantageous that, despite a running motor, the seat bench can be unlocked after it has been ensured by using the occupancy sensor that there is no driver sitting on the single-track motor vehicle.

In a preferred embodiment of the method, the seat bench has an electric motor and, after the unlocking, the seat bench is opened by means of the electric motor. As a result, the seat bench opens automatically after the unlocking, whereby the handling for the driver is further optimized.

According to the invention, a device for carrying out a method for unlocking and locking a seat bench of a single-track motor vehicle according to the above disclosure, having at least one actuator for unlocking and for locking the seat bench by means of a locking element, is also proposed. An actuating element for the actuator is formed on the seat bench, and the single-track motor vehicle has sensors for detecting current operating parameters of the single-track motor vehicle and a controller for controlling the actuator. Furthermore, at least one defined value for the corresponding operating parameters is stored in the controller and, if the detected operating parameter corresponds to the corresponding defined value and the actuating element is actuated, the actuator is controllable by means of the controller in such a way that the seat bench is unlocked by means of the locking element.

The features disclosed above can be combined as desired, to the extent that this is technically possible and these do not contradict one another.

Other advantageous developments of the invention are identified in the sub-claims and will be illustrated in more detail below together with the description of the preferred embodiment of the invention and with reference to the figures.

### BRIEF DESCRIPTION OF THE DRAWINGS

FIG. 1 is a schematic diagram of a device for carrying out a method for unlocking and locking a seat bench of a single-track motor vehicle; and

FIG. 2 is a flowchart of a method for unlocking a seat bench of a single-track motor vehicle by using the device.

The figures are schematic by way of example. The same designations in the figures refer to the same functional and/or structural features.

### DETAILED DESCRIPTION OF THE DRAWINGS

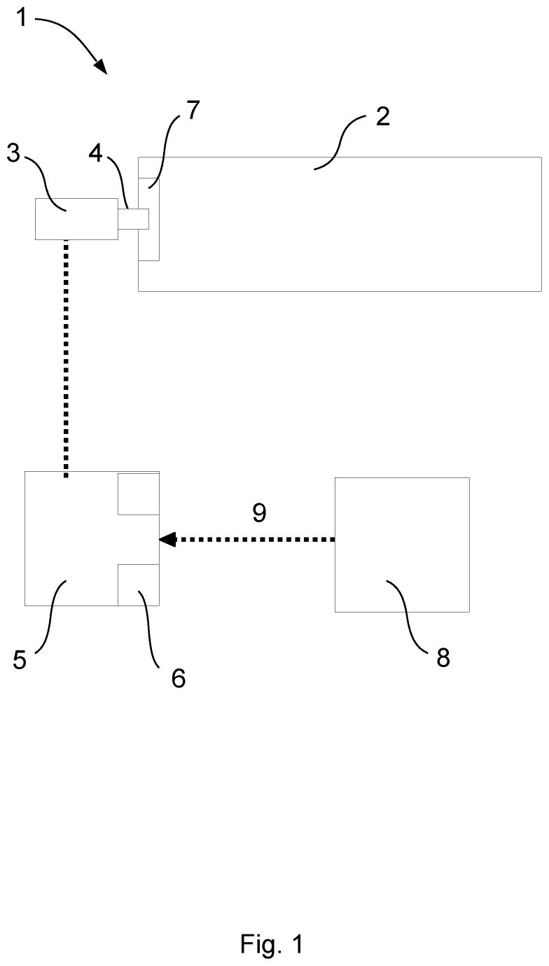

FIG. 1 illustrates a schematic view of a device 1 for carrying out a method for unlocking and locking a seat bench 2 of a single-track motor vehicle.

The device 1 comprises an actuator 3 for unlocking and for locking the seat bench 2 by way of a locking element 4. Furthermore, an actuating element 7 for the actuator 3 is formed on the seat bench 2. In addition, the single-track motor vehicle has sensors 8 for detecting current operating parameters 9 of the single-track motor vehicle, and a controller 5 for controlling the actuator 3. Defined values 6 for the corresponding operating parameters 9 are stored in the controller 5. Furthermore, if the detected operating parameter 9 corresponds to the corresponding defined value 6 and the actuating element 7 is actuated, the actuator 3 can be controlled by the controller 5 in such a way that the seat bench 2 is unlocked by the locking element 4. The actuating element 7 is an induction loop, which is arranged in a grip recess of the seat bench 2.

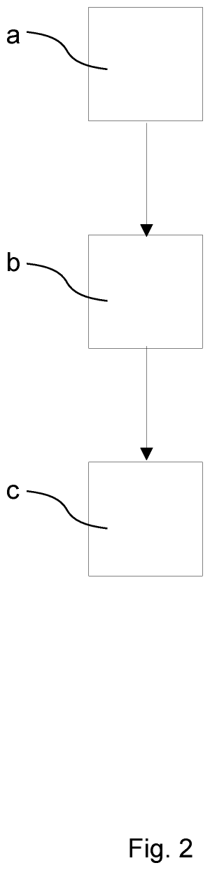

FIG. 2 is a flowchart of a method for unlocking a seat bench 2 of a single-track motor vehicle using the above-described device 1. The method comprises, with step a), firstly continuously detecting the appropriate operating parameters 9 by use of the sensors 8 and, with step b), then comparing the detected operating parameters 9 with the respective corresponding defined value 6 by means of the controller 5.

If, in the comparison, the detected operating parameter 9 corresponds to the corresponding defined value 6 and a driver actuates the actuating element 7, the controller 5 then controls the actuator 3 in step c) in such a way that the seat bench 2 is unlocked by means of the locking element 4. If one of the detected operating parameters 9 deviates from the corresponding defined value 6, the seat bench is not unlocked.

During the detection, a status of an ignition of the single-track motor vehicle is determined as an operating parameter 9, and the corresponding value 6 is an ignition switched on. Furthermore, a detected radio key is determined as an operating parameter 9, and the corresponding value 6 is a detected radio key which is located within a predetermined distance from the seat bench 2 or the single-track motor vehicle, preferably within one meter. Furthermore, a wheel rotational speed of the single-track motor vehicle is determined as an operating parameter 9, and the associated value 6 is a wheel rotational speed of 0.

Furthermore, the seat bench 2 has an occupancy sensor and occupation of the seat bench 2 and a motor speed of the single-track motor vehicle are determined during the detection. The values 6 are an unoccupied seat bench 2 and a motor speed greater than 0. In addition, the seat bench comprises an electric motor and, after the unlocking, the seat bench 2 is opened by means of the electric motor.

The invention is not restricted in its implementation to the preferred exemplary embodiments defined above. Instead, a number of variants which make use of the illustrated solution, even in basically other types of embodiments, are conceivable.

1.-9. (canceled)

10. A method for unlocking a seat bench of a single-track motor vehicle using at least one actuator that actuates a locking element, wherein an actuating element for the actuator is formed on the seat bench, the method comprising the steps of:
a. continuously detecting, via sensors for detecting corresponding operating parameters of the single-track motor vehicle, the corresponding operating parameters by way of the sensors;
b. comparing, via a controller, detected corresponding operating parameters with a respective corresponding defined value, wherein at least one defined value for the corresponding operating parameters is stored in the controller,
wherein when, in the comparing, the detected operating parameter corresponds to the corresponding defined value and a driver actuates the actuating element, the controller controls the actuator such that the seat bench is unlocked by the locking element.

11. The method according to claim 10, wherein the actuating element is a handle, a lever, a sensor, an induction loop, a switch or a pushbutton.

12. The method according to claim 10, wherein
a status of an ignition of the single-track motor vehicle is determined as an operating parameter during the detecting, and
at least one defined value is an ignition switched on.

13. The method according to claim 10, wherein
a detected radio key is determined as the operating parameter during the detection, and
the at least one defined value is a detected radio key which is located within a specified distance from a radio receiver of the single-track motor vehicle.

14. The method according to claim 13, wherein
the specified distance is within two meters.

15. The method according to claim 10, wherein
a status of an ignition lock of the single-track motor vehicle is determined as the operating parameter during the detection, and
the at least one defined value is a key inserted into the ignition lock.

16. The method according to claim 10, wherein
a wheel rotational speed of the single-track motor vehicle is determined as the operating parameter during the detection, and
the at least one defined value is a wheel rotational speed of 0.

17. The method according to claim 10, wherein
the seat bench has an occupancy sensor and occupation of the seat bench and a motor speed of the single-track motor vehicle are determined as operating parameters during the detection,
wherein the at least one defined value is an unoccupied seat bench and a motor speed of greater than 0.

18. The method according to claim 10, wherein the seat bench has an electric motor and, after the unlocking, the seat bench is opened by the electric motor.

19. A device for unlocking and locking a seat bench of a single-track motor vehicle, comprising:
at least one actuator for unlocking and for locking the seat bench by way of a locking element;
an actuating element for the actuator formed on the seat bench for detecting current operating parameters of the single-track motor vehicle; and
a controller for controlling the actuator,
wherein at least one defined value for the corresponding operating parameters is stored in the controller,
wherein, when the detected operating parameter corresponds to the corresponding defined value and the actuating element is actuated, the actuator is controllable, via the controller, such that the seat bench is unlocked by the locking element.
